(19) United States
(12) Patent Application Publication
(10) Pub. No.: US 2010/0329639 A1
(43) Pub. Date: Dec. 30, 2010

(54) APPARATUS AND METHOD FOR PROTECTING COPYRIGHT FOR MOTION PICTURE AND RECORD MEDIUM

(75) Inventors: Young Suk YOON, Seoul (KR); Won Young Yoo, Daejeon (KR); Yong Seok Seo, Daejeon (KR); Sang Kwang Lee, Daejeon (KR); Seung Jae Lee, Daejeon (KR); Jung Ho Lee, Wonju-si (KR); Young Ho Suh, Daejeon (KR); Do Won Nam, Daejeon (KR); Jee Hyun Park, Daejeon (KR); Kwang Hyun Shim, Daejeon (KR); Sung Min Kim, Busan (KR); Jung Hyun Kim, Daejeon (KR)

Correspondence Address: AMPACC Law Group, PLLC;LOADING..., 6100 219th Street SW, Suite 580, Mountlake Terrace, WA, 98043, US

(73) Assignee: Electronics and Telecommunications Research Institute, Daejeon (KR)

(21) Appl. No.: 12/616,509

(22) Filed: Nov. 11, 2009

(30) Foreign Application Priority Data
Jun. 30, 2009 (KR) 10-2009-0059357

(51) Int. Cl. H04N 5/91

(52) U.S. Cl. 386/252; 386/E05.003

(57) ABSTRACT

Provided are an apparatus and method for processing motion picture and a record medium, which decompose a motion picture into unit frames and insert copyright information into the unit frames, enabling to determine the infringement of copyright when the motion picture is illegally circulated. The apparatus includes a processing unit, a merging unit and an output unit. The processing unit decomposes a motion picture into a plurality of unit frames, and generates a main frame, a sub-frame including copyright information for the motion picture and a degree frame which is paired with the sub-frame, based on the unit frames. The merging unit merges the sub-frame into the main frame according to a degree of mergence of the degree frame. The output unit continuously outputs the merged frames in time order.

### CROSS-REFERENCE TO RELATED APPLICATIONS

This application claims priority under 35 U.S.C. §119 to Korean Patent Application No. 10-2009-59357, filed on Jun. 30, 2009, in the Korean Intellectual Property Office, the disclosure of which is incorporated herein by reference in its entirety.

### TECHNICAL FIELD

The following disclosure relates to the protection of copyright for motion picture, and in particular, to an apparatus and method for protecting copyright of motion picture and a record medium, which decompose a motion picture into unit frames and insert copyright information into the unit frames, enabling to determine the infringement of copyright when the motion picture is illegally circulated.

### BACKGROUND

As Internet technology rapidly progresses, various works are digitalized and thereby distributed and circulated widely. In motion picture and image to which creativity is added, the copying and processing of images are easy and may be performed even at low cost due to acquisition devices such as camcorders, printers and scanners, and all sorts of programs. In particular, an authorized user, which has purchased an image or a motion picture that is provided with charge over Internet, illegally circulates the purchased image or motion picture to make illegal profits. This infringement of digital works frequently occurs.

For solving these problems, Korean Patent No. 10-0665711 entitled “Image Protection Method Using Overlay in Image Viewer” discloses a method of disallowing images to be copied and circulated as a technology that processes images provided from an image viewer, by using an overlay not to be captured.

And, a method has been disclosed that prevents illegal copy by using an overlay screen for a specific region having a boundary in images.

However, the related technologies are for the still images. Therefore, it is unsuitable to apply the related technologies to the motion pictures, because of increase of a processing amount and the characteristics of the motion pictures that are continuously outputted for an allotted time.

### SUMMARY

In one general aspect, an apparatus for protecting copyright for motion picture includes: a processing unit decomposing a motion picture into a plurality of unit frames, and generating a main frame, a sub-frame including copyright information for the motion picture, and a degree frame which is paired with the sub-frame, based on the unit frames; a merging unit merging the sub-frame into the main frame according to a degree of mergence of the degree frame; and an output unit continuously outputting the merged frames in time order.

In another general aspect, a method for protecting copyright for motion picture includes: decomposing a motion picture into a plurality of unit frames; inserting copyright information of the motion picture into the unit frames; and continuously outputting the unit frames into which the copyright information is inserted, in time order.

In another general aspect, a computer-readable record medium, storing a program for executing a method for protecting copyright for motion picture, executes: decomposing a motion picture into a plurality of unit frames; generating a main frame, a sub-frame including copyright information for the motion picture and a degree frame which is paired with the sub-frame, based on the unit frames; processing the sub-frame on the basis of the degree frame to merge the processed sub-frame into the main frame; and continuously outputting the merged frames in time order.

Other features and aspects will be apparent from the following detailed description, the drawings, and the claims.

### BRIEF DESCRIPTION OF THE DRAWINGS

FIG. 1 is a block diagram illustrating an apparatus for protecting copyright for motion picture according to an exemplary embodiment.

FIG. 2 is a conceptual view for describing the operation of a processing unit in FIG. 1.

FIG. 3 is a conceptual view for describing the operation of a merging unit in FIG. 1.

FIG. 4 is a flow chart schematically illustrating a method for protecting copyright for motion picture according to an exemplary embodiment.

FIG. 5 is a flow chart illustrating the segmentation of an operation for inserting copyright information in the method for protecting copyright in FIG. 4.

FIG. 6 is a flow chart illustrating an example of mechanism in which copyright are infringed when a motion picture is illegally diffused.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

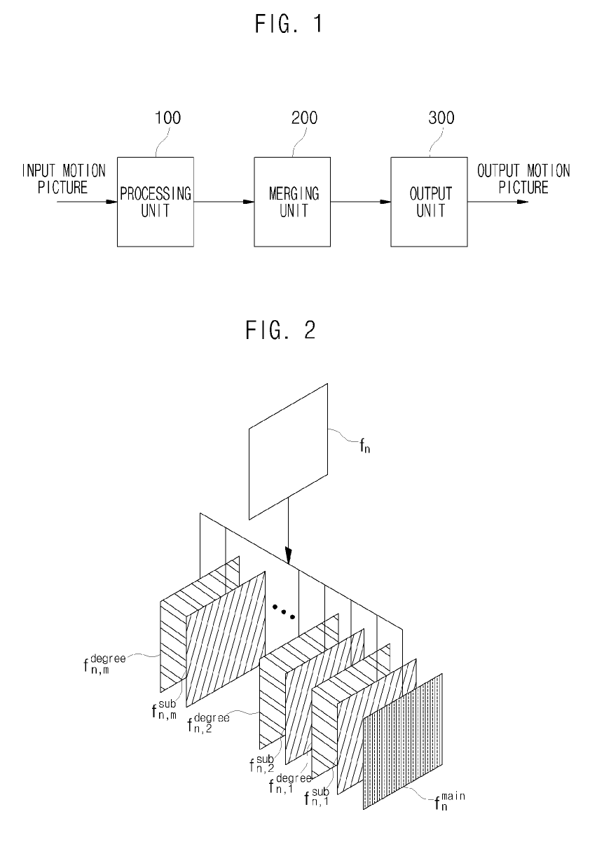

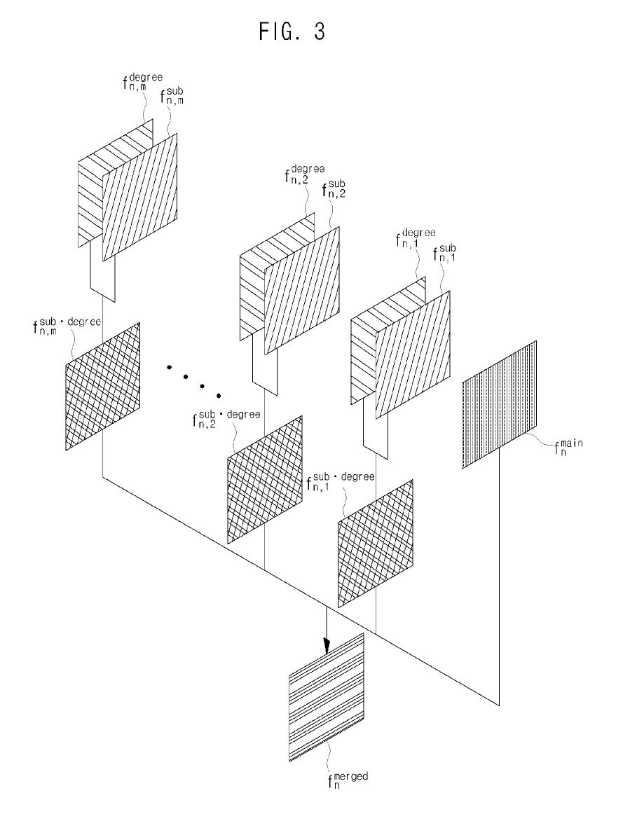

Hereinafter, an apparatus for protecting copyright for motion picture according to an exemplary embodiment will be described below with reference to FIGS. 1 to 3. FIG. 1 is a block diagram illustrating an apparatus for protecting copyright for motion picture according to an exemplary embodiment. FIG. 2 is a conceptual view for describing the operation of a processing unit in FIG. 1. FIG. 3 is a conceptual view for describing the operation of a merging unit in FIG. 1.

An apparatus for protecting copyright for motion picture according to an exemplary embodiment includes a processing unit 100, a merging unit 200, and an output unit 300.

The processing unit 100 decomposes an input motion picture into unit images, for example, unit frames of picture. Since the unit frame is a picture at a specific time in a motion picture, the unit frame decomposed by the processing unit 100 is in plurality. The processing unit 100 generates a main frame, a sub-frame and a degree frame on the basis of the decomposed unit frame.

The main frame may be the unit frame of picture itself, or a picture that is modified through an operation such as filtering or calculation based on the purpose of an entire system using an apparatus according to exemplary embodiment or characteristic of a motion picture.

The sub-frame is a picture for protecting the main frame and includes copyright information for a motion picture. The sub-frame may be independent of or dependent on the main frame. Herein, an independent sub-frame is a picture that is independently generated in the processing unit 100 with no reference to information for the main frame. The dependent sub-frame is a picture that is generated in the processing unit 100 with reference to information for the main frame. The purpose of an entire system or characteristic of a motion picture may be an example of information for the main frame. The sub-frame may be generated based on a previous unit frame or a next unit frame with respect to a unit frame at a specific time by using a memory such as a buffer. The sub-frame may include an overlay or a scaler.

The copyright information may include provider information, creator information and purchase information. The copyright information may be pre-stored in the processing unit 100 or inputted by an external user or system administrator. Examples of the copyright information inputted by the user may include information for a purchaser that has purchased a motion picture and serial numbers for purchase. For example, when the purchaser information or the serial numbers for purchase is inputted, infringement of digital works such that an authorized user (which has purchased a motion picture) illegally circulates the purchased motion picture to make illegal profits can be prevented.

A degree frame is one that controls a degree of mergence between a main frame and a sub-frame, and is paired with the sub-frame. The degree of mergence may be controlled according to a control signal. When the degree of mergence is strong, copyright information included in the sub-frame is largely reflected in the main frame. When the degree of mergence is weak, the copyright information included in the sub-frame is minimally reflected in the main frame. Copyright information may be inserted to be visible or to be invisible by a degree frame.

Hereinafter, the processing unit 100 in FIG. 1 will be described in detail with reference to FIG. 2.

The processing unit 100 generates a main frame fₙ^{main}, a sub-frame f_{n,m}^{sub} and a degree frame f_{n,m}^{degree} on the basis of a unit frame fₙ. Since the main frame fₙ^{main} is a frame itself (or a modified frame) at a specific time among a motion picture, it is one frame. However, there can be one or more pairs of the sub-frame f_{n,m}^{sub} and the degree frame f_{n,m}^{degree}, depending on the case. In FIG. 2, fₙ^{main} the main frame of the nth unit frame fₙ among a motion picture, f_{n,m}^{sub} is the mth sub-frame of the main frame fₙ^{main}, and f_{n,m}^{degree} frame that is paired with the mth sub-frame f_{n,m}^{sub} of the main frame fₙ^{main}.

Since digital works may include contents that a copyright owner intends to widely distribute free of charge, the processing unit 100 checks whether the copyright protection of a motion picture is required or not. When the protection of the copyright is required, the processing unit 100 generates the main frame, the sub-frame and the degree frame. Checking whether the protection of the copyright is required may be performed before or after decomposing into the unit frame.

The merging unit 200 receives the main frame, the sub-frame and the degree frame that are generated in the processing unit 100 and generates a new frame including copyright information. The new frame is generated by merging the sub-frame into the main frame according to a degree of mergence of the degree frame.

Hereinafter, the merging unit 200 will be described in detail with reference to FIG. 3.

As an operation example of the merging unit 200, the merging unit 200 may process the sub-frame using the degree frame before merging the sub-frame into the main frame. For example, as illustrated in FIG. 3, the merging unit 200 may reflect the degree frame f_{n,m}^{degree} to process the sub-frame f_{n,m}^{sub} through a processing scheme such as point processing, block processing, region processing or geometric processing. Information of a degree of mergence is included in the processed sub-frame f_{n,m}^{sub.degree} which is the result material of the process. The number of the processed sub-frames f_{n,m}^{sub.degree} is the same as the number of sub-frame f_{n,m}^{sub}-degree frame f_{n,m}^{degree} pairs that are generated in the processing unit 100. Subsequently, the processed sub-frames f_{n,m}^{sub.degree} is merged with the main frame fₙ^{main}, whereupon a new frame fₙ^{merged} is generated. The degree in which the processed sub-frames f_{n,m}^{sub.degree} is merged with the main frame fₙ^{main} is proportional to the degree of mergence.

Examples of a method, in which a processed sub-frame is merged into a main frame, includes a method that merges at least some pixels of a processed sub-frame into a main frame according to a degree of mergence and a method that gives a weight to a processed sub-frame to merge the weight-given sub-frame into a main frame according to a degree of mergence. A method, in which a processed sub-frame is merged into a main frame, may be selected according to an external control signal.

The output unit 300 continuously outputs new frames, generated through mergence, to visualize a motion picture. New frames generated in the merging unit 200 may be sequentially processed in the merging unit 200, and the sequentially-processed frames may be outputted to the output unit 300 to be visualized. Alternatively, the new frames may be sequentially processed in the output unit 300 to be visualized.

The output unit 300 may include all sorts of motion picture replaying devices such as a set-top box, a personal video player, a recorder and a video game player.

The processing unit 100, the merging unit 200 and the output unit 300 are included in one device, or they may be connected to a dedicated network such as a home network. Or, the processing unit 100, the merging unit 200 and the output unit 300 exist over a wide area network, and they may be configured to process a processed result through wired or wireless communication.

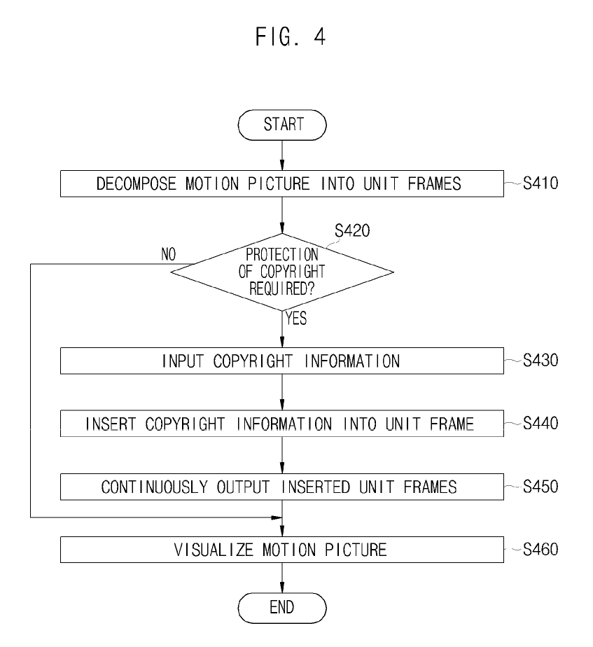

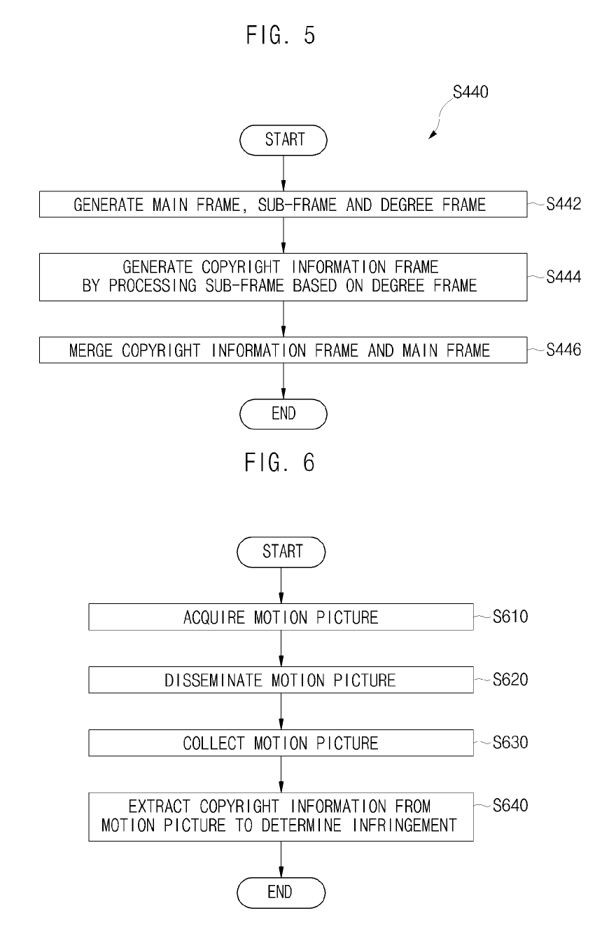

Hereinafter, a method for protecting copyright for motion picture according to an exemplary embodiment will be described with reference to FIGS. 4 and 5. FIG. 4 is a flow chart schematically illustrating a method for protecting copyright for motion picture according to an exemplary embodiment. FIG. 5 is a flow chart illustrating the segmentation of an operation for inserting copyright information in the method for protecting copyright in FIG. 4.

First, a motion picture, which is replayed for an allotted time, is decomposed into unit frames in operation S410. For example, the unit image may be a unit frame, and the number of the unit frames is in plurality.

A motion picture may require a different level of protection, such as strong, weak, or no protection, according to the purpose and characteristic of the motion picture. Accordingly, determining whether the copyright protection of the motion picture is required to protect copyright coincides with a copyright owner's intention, and thus the apparatus checks whether the protection of copyright is required in operation S420. This may be selectively performed in consideration of the purpose or characteristic of the motion picture. When the protection of copyright is not required, the apparatus does not perform operations S430 to S450 that will be described below and visualizes the motion picture through an output device such as a video player in operation S460, thereby securing the economy of a system. In FIG. 4, operation S420 of checking whether the protection of copyright is required is performed after operation S410, but operation S420 may be performed before operation S410.

Subsequently, the apparatus may receive copyright information for a motion picture to be protected in operation S430. The copyright information may include information such as a creator, a copyright owner, a distributor and a purchaser that purchases a motion picture. This operation is disclosed to be performed after below-described operation S410 of decomposing the unit frame, in FIG. 4. However, operation S430 can be performed at any time before operation S440 of inserting copyright information into a unit frame.

The copyright information of the motion picture is inserted into the decomposed unit frame in operation S440. The following description will be made in detail with reference to FIG. 5 on an example of operation S440.

The main frame, the sub-frame and the degree frame are generated on the basis of the unit frame in operation S442 (a first generation operation). The sub-frame may have copyright information for the motion picture. The degree frame is generated to be paired with the sub-frame, and the degree frame may have a degree of mergence which is information on intensity where the sub-frame is merged into the main frame.

A copyright information frame which is the processed sub-frame in operation S444 (a second generation operation) is generated by processing the sub-frame on the basis of the degree frame. The copyright information frame includes the copyright information of the motion picture. Because information on degree, in which the copyright information frame is merged with the main frame, is reflected in the copyright information frame that is generated through operation S444, the copyright information frame and the main frame are merged on the basis of the intensity in operation S446.

A method that reflects the degree frame to process the sub-frame applies point processing, region processing, geometric processing and/or block processing.

This method may be controlled according to a predetermined signal.

The following description will be made on a computer-readable record medium for protecting copyright for a motion picture using sub-frames. The record medium includes a program which executes decomposing a motion picture into unit frames; generating a main frame, a sub-frame and a degree frame; merging the frames; and continuously outputting the merged frames in time order. When sub-frame-degree frame pair is in plurality, the record medium may include a program that processes each of the sub-frames to generate a plurality of processed sub-frames and allows the processed sub-frames and the main frame to be merged. In this way, since each operation executed in the record medium corresponds to the apparatus and method for protecting copyright for a motion picture that have been described above, the above description of the apparatus and method will be applied to the record medium.

The record medium may include a program that executes checking whether copyright for a motion picture is protected. Checking whether copyright for a motion picture is protected may be performed before and after executing decomposing the motion picture.

When the record medium pre-stores copyright information for the motion picture, each operation may be executed using the pre-stored copyright information. Alternatively, the program may receive copyright information from an external user to execute the received information. Even when the copyright information is pre-stored, the program may receive additional copyright information from the user to execute the received information.

The computer-readable record medium is any data storage device that can store data which can be thereafter read by a computer system. Examples of the computer-readable record medium include ROMs, RAMs, CD-ROMs, DVDs, magnetic tapes, floppy disks, registers, buffers, optical data storage devices, and carrier waves (such as data transmission through the Internet). The computer-readable record medium can also be distributed over network coupled computer systems so that the computer readable codes are stored and executed in a distributed fashion. Also, functional programs, codes, and code segments for accomplishing the present invention can be easily construed by programmers skilled in the art to which the present invention pertains.

The following description will be made on an example of mechanism in which copyright are protected when a motion picture is illegally circulated. A motion picture, which is obtained through the apparatus and method for protecting copyright or a record medium according to an exemplary embodiment, is distributed for a fee or free of charge. A viewer may illegally acquire a motion picture into which copyright information is inserted, with unlawful intent in operation S610. The illegally-acquired motion picture is disseminated to another viewer through a shared path such as webhard/p2p or another record medium in operation S620. When the disseminated motion picture is disseminated without a copyright owner's consent, the copyright of the disseminated motion picture are infringed.

At this point, the copyright owner collects the disseminated motion picture in operation S630, and may extract copyright information from the collected motion picture to determine whether the copyright are infringed in operation S640.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for protecting copyright for motion picture, comprising:
a processing unit decomposing a motion picture into a plurality of unit frames, and generating a main frame, a sub-frame comprising copyright information for the motion picture, and a degree frame which is paired with the sub-frame, based on the unit frames;
a merging unit merging the sub-frame into the main frame according to a degree of mergence of the degree frame; and
an output unit continuously outputting the merged frames in time order.

2. The apparatus of claim 1, wherein the processing unit checks whether protection of copyright for the motion picture is required, and generates the main frame, the sub-frame and the degree frame when the protection of the copyright is required.

3. The apparatus of claim 1, wherein more than one pair of the sub-frame and the degree frame are generated for each main frame.

4. The apparatus of claim 1, wherein the copyright information is provided from the outside.

5. The apparatus of claim 4, wherein the copyright information comprises purchaser information for the motion picture.

6. The apparatus of claim 1, wherein the merging unit merges the sub-frame into the main frame according to a control signal for a mergence scheme.

7. The apparatus of claim 1, wherein the merging unit merges at least some pixels of the sub-frame into the main frame.

8. The apparatus of claim 1, wherein the merging unit gives a weight to the sub-frame to merge the weight-given sub-frame into the main frame.

9. A method for protecting copyright for motion picture, comprising:
decomposing a motion picture into a plurality of unit frames;
inserting copyright information of the motion picture into the unit frames; and
continuously outputting the unit frames into which the copyright information is inserted, in time order.

10. The method of claim 9, wherein the inserting of copyright information comprises:
generating a main frame and a copyright information frame on the basis of the unit frame; and
merging the copyright information frame into the main frame.

11. The method of claim 10, wherein the generating of a main frame and a copyright information frame comprises:
generating a sub-frame comprising copyright information for the motion picture and a degree frame comprising a degree of mergence; and
generating the copyright information frame by processing the sub-frame on the basis of the degree frame.

12. The method of claim 10, wherein the copyright information frame is merged into the main frame according to a control signal in the merging the copyright information frame.

13. The method of claim 9, further comprising checking whether to protect copyright for the motion picture.

14. The method of claim 9, further comprising receiving the copyright information for the motion picture.

15. A computer-readable record medium storing a program for executing a method for protecting copyright for motion picture, the method comprising:
decomposing a motion picture into a plurality of unit frames;
generating a main frame, a sub-frame comprising copyright information for the motion picture, and a degree frame which is paired with the sub-frame, based on the unit frames;
processing the sub-frame on the basis of the degree frame to merge the processed sub-frame into the main frame; and
continuously outputting the merged frames in time order.

16. The computer-readable record medium of claim 15, wherein the computer-readable record medium further executes checking whether to protect copyright for the motion picture.

17. The computer-readable record medium of claim 15, wherein the computer-readable record medium further executes receiving the copyright information for the motion picture.

18. The computer-readable record medium of claim 15, wherein when the sub-frame and the degree frame form a plurality of pairs, the computer-readable record medium further executes processing each of the sub-frames, and merging the processed sub-frames and the main frame.
